(19) United States
(12) Patent Application Publication
(10) Pub. No.: US 2026/0084781 A1
(43) Pub. Date: Mar. 26, 2026

(54) DRIVE DEVICE FOR AN ELECTRIC BICYCLE

(71) Applicant: Porsche eBike Performance GmbH, Ottobrunn (DE)

(72) Inventor: Ulrich Klose, Hesperange (LU)

(21) Appl. No.: 19/332,969

(22) Filed: Sep. 18, 2025

(30) Foreign Application Priority Data
Sep. 20, 2024 (DE) 10 2024 127 254.6

(51) Int. Cl. B62M 6/55; B62M 6/50; B62M 11/14

(52) U.S. Cl. CPC B62M 6/55; B62M 6/50; B62M 11/145

(57) ABSTRACT

A drive device for an electric bicycle has an epicyclic gearbox with three elements. The three elements are all mounted so that they can rotate around the same axis of rotation. The drive device also has a pedal shaft coupled to a first of the three elements in order to feed torque into the epicyclic gearbox. The drive device has a motor coupled to a second of the three elements to feed torque into the epicyclic gearbox. In addition, the drive device has an output element coupled to a third of the three elements to divert torque from the epicyclic gearbox. The drive device has only a single motor coupled to the output element in such a way that torque can be transmitted from this motor to the output element, this motor being the motor coupled to the second element.

### CROSS-REFERENCE TO RELATED APPLICATIONS

This application claims priority of German patent application no. 10 2024 127 254.6, filed Sep. 20, 2024, the entire content of which is incorporated herein by reference.

### TECHNICAL FIELD

A drive device for an electric bicycle is described. In addition, a method for operating a drive device for an electric bicycle and an electric bicycle are described.

### BACKGROUND

Bicycles are a cost-effective, easy-to-use, and emission-free means of transportation. They have also become popular as sports and fitness equipment, and certain types have proven to be particularly suitable for various athletic applications.

In recent years, enthusiasm for electric bicycles (especially so-called “pedelecs”) has been growing, despite their high weight and price compared to conventional bicycles. In the case of electric bicycles, it is important to provide a reliable drive device.

### SUMMARY

It is an object of the disclosure to specify a drive device for an electric bicycle in which the power transmission, gear function, and shifting function of an electric bicycle are realized in a simple and compact configuration. Further objects include specifying a method for operating such a drive device and an electric bicycle with such a drive device.

First, a drive device for an electric bicycle is specified.

According to an embodiment, the drive device for an electric bicycle has an epicyclic gearbox with three elements, wherein the three elements are all rotatably mounted about the same rotational axis. Furthermore, the drive device has a pedal shaft that is coupled to a first of the three elements to feed torque into the epicyclic gearbox. The drive device has a motor coupled to a second of the three elements to feed torque into the epicyclic gearbox. In addition, the drive device has an output element coupled to a third of the three elements to divert torque from the epicyclic gearbox. The drive device has only a single motor that is coupled to the output element in such a way that torque can be transmitted from this motor to the output element, this motor being the motor coupled to the second element.

The present disclosure is based, inter alia, on the realization that continuously variable shifting and motor assistance during operation of the electric bicycle can be achieved in a simple and cost-effective manner via a single motor coupled to an epicyclic gearbox. The motor can then be used to specify both the transmission ratio and the assist torque.

The epicyclic gearbox may have one or more epicyclic gearbox stages. In addition to the first, second, and third elements, the epicyclic gearbox may have further elements. For example, the first and second elements are elements of the same epicyclic gearbox stage. The third element may also be an element of the same epicyclic gearbox stage as the first and second elements, or may be an element of a different epicyclic gearbox stage.

The first, second, and third elements of the epicyclic gearbox all rotate around the same rotational axis during operation. This rotational axis may coincide with the rotational axis of the pedal shaft and/or the rotational axis of the motor and/or the rotational axis of the output element. In each case, the rotation takes place, for example, relative to a housing element of the drive device.

The fact that the pedal shaft is coupled to the first element of the epicyclic gearbox means that the pedal shaft is coupled to the first element before other elements of the epicyclic gearbox, in particular before the second and third elements. The coupling of the pedal shaft to the first element can be direct or indirect. “Direct” means that the pedal shaft is directly connected to the first element. “Indirect” means that the pedal shaft is coupled to the first element via intermediate elements. For example, the pedal shaft is then coupled to the first element via an intermediate gear stage and/or a chain and/or a belt.

The intermediate gear stage is, for example, a bevel gear stage or spur gear stage.

The pedal shaft and the first element can be coupled together in a rotationally fixed manner so that rotation of the pedal shaft, regardless of the rotational direction, always leads to rotation of the first element and vice versa. Alternatively, the pedal shaft may be coupled to the first element via a freewheel, so that the pedal shaft and the first element can rotate relative to each other in one rotational direction and can only rotate together in the other rotational direction.

All previously disclosed features for the coupling between the pedal shaft and the first element of the epicyclic gearbox also apply in respective manner to the coupling between the motor and the second element or to the coupling between the output element and the third element.

The pedal shaft is coupled or can be coupled in particular with pedal cranks in order to be driven manually by a rider of the electric bicycle. The motor is in particular an electric motor. The electric motor can be an internal rotor or an external rotor. The motor may be flanged to the pedal shaft. The output element is, for example, a chainring or a chainring spider. Alternatively, the output element may also be a rotatable hub housing.

The drive device may be arranged in the pedal crank housing or form the same. The drive device is, for example, a mid-motor drive device. Alternatively, the drive device may be a hub drive device in which the motor is located in the hub housing. The pedal shaft may then extend through a wheel, for example the rear wheel, of the electric bicycle, as in a unicycle. Alternatively, the pedal shaft could also be coupled to the first element via a belt or chain.

The drive device has only a single motor with which torque can be transmitted to the output element. Any other motor of the drive device cannot be used to exert torque on the output element.

According to a further embodiment, the motor is a brush motor, in particular a so-called brush DC motor. The brush motor may have permanent magnets, which are arranged in the stator, for example. Alternatively, the motor may also be a brushless motor, in particular a so-called brushless DC motor (BLDC). The brushless motor may also have permanent magnets. These are arranged in the rotor, for example.

One advantage of a brush motor is that it delivers high starting torque. It can also be used as a generator, for example when riding an electric bicycle downhill or when braking. The electronic control of a brush motor is relatively simple and therefore inexpensive. A brushless motor offers the advantage of higher rotational speeds in most cases. It also requires less maintenance.

According to a further embodiment, the rotational speed of the motor is continuously adjustable. For example, the drive device further includes a PWM generator with which the motor is controlled. The rotational speed can be continuously specified by adjusting the PWM signal. The PMW generator can be part of a control device of the drive device.

According to a further embodiment, the first element is a carrier on which an epicyclic gear is mounted so as to be rotatable. During operation, the carrier rotates about the rotational axis. The epicyclic gear runs around the rotational axis of the carrier. A rotational axis of the epicyclic gear is, for example, parallel to the rotational axis of the carrier, but offset relative to it.

According to a further embodiment, the second element is a gear that is in engagement with the epicyclic gear. The gear can be a spur gear, a bevel gear, or a crown gear.

According to a further embodiment, the third element is another gear that is in engagement with the epicyclic gear. Alternatively, the other gear may also be in engagement with another epicyclic gear that is also mounted on the carrier so as to be rotatable and is connected to the epicyclic gear in a rotationally fixed manner. The two epicyclic gears connected to each other in a rotationally fixed manner can then only rotate together around the same rotational axis. The two rotationally fixed epicyclic gears can be arranged on different sides of the carrier. The other gear can be a spur gear, a bevel gear, or a crown gear.

Several epicyclic gears can be mounted rotatably on the carrier. For example, several epicyclic gears are arranged on the carrier in an azimuthally offset manner relative to each other. For example, three or more epicyclic gears are mounted rotatably on one side of the carrier. Each of these epicyclic gears can be connected in a rotationally fixed manner to another epicyclic gear on the other side of the carrier. Each of the epicyclic gears is in engagement with, for example, the second element or the third element.

According to an embodiment, the first element is the carrier, the second element is a gear, and the third element is a gear. However, it is also conceivable that the second element or the third element is a carrier on which at least one epicyclic gear is mounted so as to be rotatable, and the remaining two elements are gears that engage with the at least one epicyclic gear.

According to a further embodiment, the epicyclic gearbox is a planetary gearbox. In this case, the epicyclic gear or gears are planetary gears. For example, it is a planetary gearbox with one or two planetary gearbox stages. The first element is, for example, a planet carrier, the second element is a sun gear, and the third element is a ring gear. However, a different arrangement is also conceivable. For example, the three elements are assigned to the same planetary stage. Alternatively, if the planetary gearbox has two or more planetary gear stages, the third element can also be another sun gear that is assigned to a different planetary stage than the first element and the second element.

According to a further embodiment, the epicyclic gearbox is a bevel gear differential gearbox. The first element is then, for example, an epicyclic gear carrier, the second element a bevel gear, and the third element another bevel gear. However, a different assignment is also conceivable here. In this case, the epicyclic gear or gears are epicyclic bevel gears that mesh with the bevel gear and the other bevel gear.

According to a further embodiment, the epicyclic gearbox is a crown gear differential gearbox. The first element is then, for example, an epicyclic gear carrier, the second element a crown gear, and the third element another crown gear. However, a different arrangement is also conceivable here. In this case, the epicyclic gears are epicyclic spur gears that mesh with the crown gear and the other crown gear.

According to a further embodiment, the drive device further includes a control device that is connected to the motor for signal transmission. The control device is configured to determine, in particular automatically, control information for controlling the motor depending on operating information being representative of the operation of the electric bicycle.

The operating information is, for example, measured variables or is determined depending on measured variables. In particular, the drive device includes one or more sensors for determining the operating information. The control information can be control signals or setpoints for controlling the motor.

According to a further embodiment, the operating information is representative of a torque exerted on the pedal shaft by a rider of the electric bicycle and/or representative of a rotational speed at which the rider rotates the pedal shaft. In particular, the drive device includes a torque sensor and/or a cadence sensor for detecting the torque or the rotational speed, respectively. The operating information is then determined based on the measurements of the torque sensor and/or cadence sensor.

According to a further embodiment, the operating information is representative of manual actuation of a control element by a rider of the electric bicycle. For this purpose, the electric bicycle or the drive device includes, for example, a manually actuatable control element.

The control element is, for example, a throttle lever or a twist grip with which the rider specifies the torque or rotational speed to be produced by the motor. The actuation of the control element by the rider is converted, for example, via the PWM generator into a PWM signal for the operation of the motor. The control element may be provided on the handlebars of the electric bicycle.

Next, the method for operating the drive device is specified. The method can be used in particular to operate the drive device described herein. In this respect, all features disclosed for the drive device are also disclosed for the method and vice versa.

According to an embodiment, the method includes providing operating information and determining control information depending on the operating information. The operating information is representative of the operation of the electric bicycle, for example representative of the actual and/or desired operation. The control information is configured for controlling the motor. The method is, in particular, a computer-implemented method. The control information is, for example, a setpoint in a control loop or an electrical signal, for example, the above-mentioned PWM signal.

Next, the electric bicycle is specified. The electric bicycle includes a drive device described herein.

Hereinafter, a drive device described herein, a method described herein, and an electric bicycle described herein are explained in more detail with reference to drawings on the basis of embodiments. The same reference signs indicate the same elements in the individual figures. Insofar as elements or components in the various figures are identical in function, their description is not repeated for each of the following figures. For reasons of clarity, elements may not be provided with respective reference signs in all figures.

### BRIEF DESCRIPTION OF DRAWINGS

The invention will now be described with reference to the drawings wherein:

FIG. 1 shows an embodiment of the electric bicycle;

FIGS. 2 to 9 show various embodiments of the drive device;

FIG. 10 shows an embodiment of the method; and,

FIG. 11 shows an embodiment of a circuit in a drive device.

### DETAILED DESCRIPTION

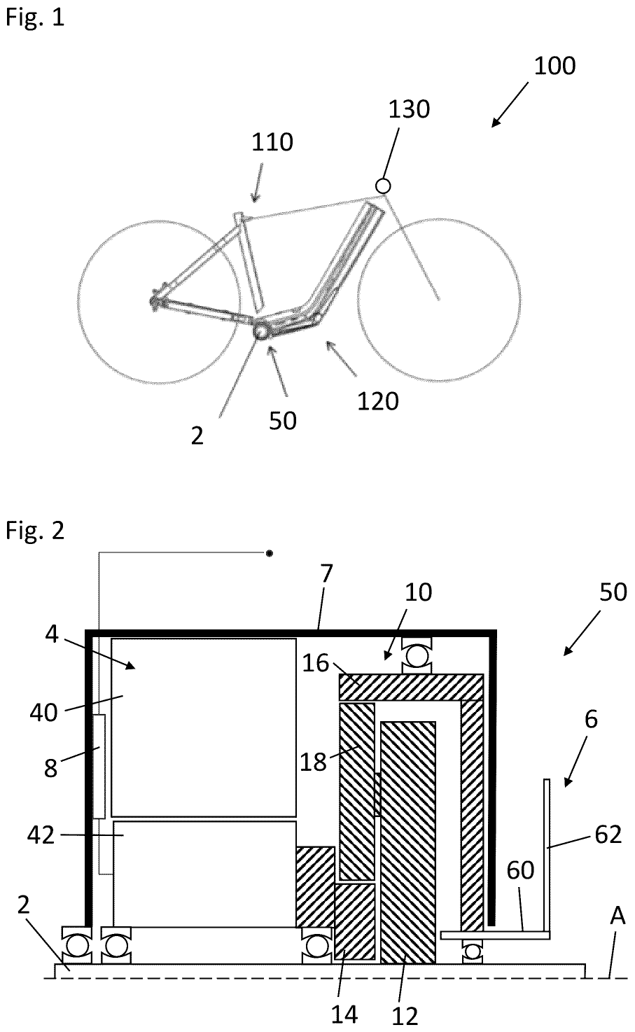

FIG. 1 schematically shows an electric bicycle 100 with a bicycle frame 110, which has a lower frame section 120. This forms a down tube. The lower frame section 120 extends in the direction of a bottom bracket of the electric bicycle 100. The bottom bracket has a pedal shaft 2, which is part of a drive device 50 installed in the bicycle. A control element 130 is located on the handlebars of the electric bicycle 100. The control element 130 may be a throttle lever or a twist grip.

FIG. 2 shows a first embodiment of the drive device 50. This is, for example, the drive device 50 of FIG. 1. The drive device 50 includes a housing 7 in which an electric motor 4 is arranged. The electric motor 4 has a stator 40 and a rotor 42. In this case, the electric motor 4 is an internal rotor motor. The electric motor 4 is, for example, a brush DC motor with permanent magnets. During operation, the rotor 42 rotates around a rotational axis A. This rotational axis A also forms the rotational axis of the pedal shaft 2, which can be manually rotated by a rider of the bicycle through a pedaling motion.

An epicyclic gearbox 10 is also provided in the housing 7. The epicyclic gearbox 10 is a planetary gearbox with a sun gear 14, a planet carrier 12, and a ring gear 16, all of which are also mounted so that they can rotate around the rotational axis A. Several planet gears 18 are mounted on the planet carrier 12 so that they can rotate. The planet gears 18 are in engagement with the ring gear 16 and the sun gear 14.

In this case, the sun gear 14 is connected to the rotor 42 of the electric motor 4 in a rotationally fixed manner, so that torque can be transmitted from the electric motor 4 to the sun gear 14. The pedal shaft 2 is connected to the planet carrier 12 in a rotationally fixed manner, so that the torque exerted on the pedal shaft 2 by a rider of the bicycle is transmitted to the sun gear 14. The ring gear 16 is connected to an output element 6 in a rotationally fixed manner. The output element 6 includes a chainring 62 which is coupled to a hollow shaft 60 of the output element 6. The hollow shaft 60 runs around the pedal shaft 2.

The drive device 50 also includes a control device 8 which is arranged in the housing 7. The control device 8 is connected, for example, to the control element 130 of the electric bicycle 100 for signal transmission. When the control element 130 is actuated, operating information is generated, which is representative of the actuation, for example, for the position to which the twist grip 130 is turned. Depending on the operating information, the control device 8 determines control information for controlling the motor 4. For example, the rotational speed of the motor 4 can be increased by turning the twist grip more strongly.

During operation of the drive device 50, a torque exerted by the rider on the pedal shaft 2 can be transmitted to the output element 6 via the planetary gearbox 10. This serves to propel the electric bicycle. By controlling the electric motor 4, additional supporting torque can be transmitted from the electric motor 4 to the output element 6 via the planetary gearbox 10. At the same time, the transmission ratio between the pedal shaft 2 and the output element 6 is changed. This is explained in more detail using an example:

For example, let us assume that the transmission ratio from the chainring to the rear wheel is 1:1. The diameter factor of the sun gear, planet gear, and ring gear is assumed to be 2:1:4. If the sun gear is now driven by the electric motor at 2 rpm and the planet carrier is stationary, the ring gear rotates at 1 rpm, which corresponds to a speed of 3.6 km/h, for example. If, on the other hand, the planet carrier rotates at 1 rpm and the sun gear is stationary, the ring gear rotates at 1.5 rpm and the bicycle then has a speed of 5.4 km/h. If both the sun gear and the planetary carrier rotate at 1 rpm each, the ring gear rotates at 2.5 rpm, which is respective to a speed of 9 km/h. If the sun gear and planetary carrier rotate at 3 rpm each, this corresponds to 7.5 rpm for the ring gear and a bicycle speed of 27 km/h.

The electric motor 4 is not only useful for propelling the electric bicycle. If the bicycle wheel driven by the chainring 62 is coupled to the chainring 62 without a freewheel, as shown in FIG. 2, the electric motor 4 can also be used for braking. The wheel drives the output element 6. The electric motor 4 can then brake more or less strongly depending on the position of the twist grip. The braking effect can be further increased, for example, by the rider pedaling backwards.

The electric motor 4 can also be used as a generator. The switch from motor to generator mode occurs automatically at the moment when the opposite current of the braking power exceeds the current of the motor power. The switchover can occur over a wide speed range up to the standstill of the electric motor. The electric motor can be magnetically blocked by bypassing the motor connections. This function can be activated by the twist grip, for example, by turning it to zero. The bicycle is then propelled solely by pedaling.

Overall, both acceleration and braking can be selected via the twist grip and by pedaling, either in combination or separately. In particular, the following riding modes are possible with the drive device 50 according to FIG. 2:
1. The rider propels the bicycle exclusively by operating the twist grip via the electric motor, that is, without pedaling.
2. The rider propels the bicycle exclusively by pedaling, that is, without the aid of the electric motor.
3. the Rider Propels the Bicycle by Pedaling and Motor assistance.
4. When riding downhill, the rider reduces the pedaling motion and turns the twist grip back until he is riding down the hill at the desired speed. In this case, the electric motor 4 can charge the electric bicycle's battery as a generator.
5. To brake, for example when riding downhill, the rider turns the twist grip back even further.
6. The rider can brake even more strongly by pedaling backwards.

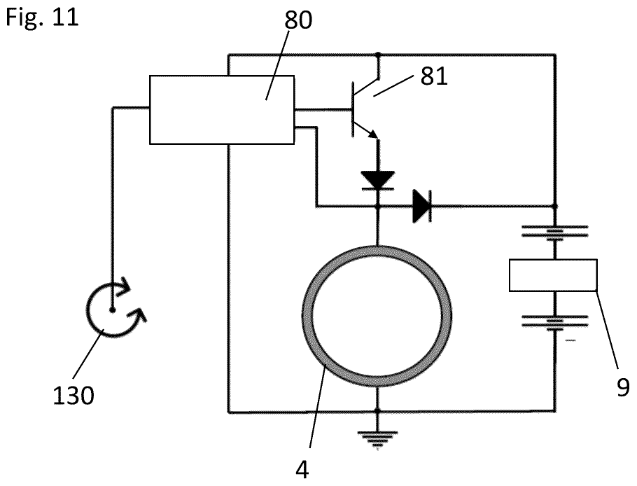

A possible circuit configuration within the drive device 50 of FIG. 2 is shown in FIG. 11. Here, the control device 8 includes a PWM generator 80 and an electrical switch 81, for example in the form of a MOSFET or IGBT. The power supply to the electric motor 4 is provided by a battery 9.

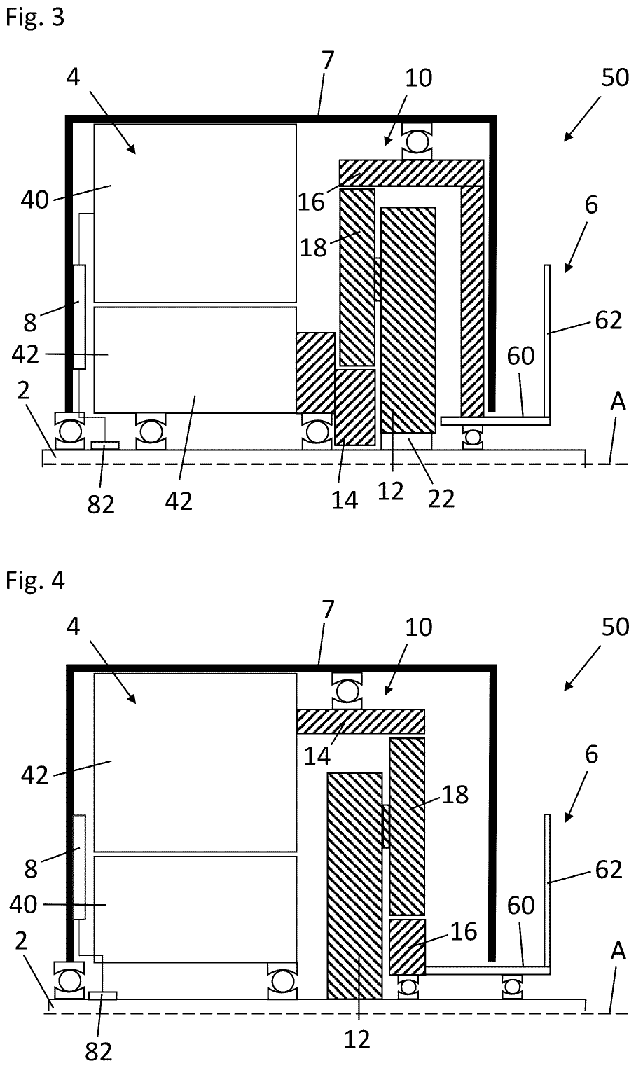

FIG. 3 shows a second embodiment of the drive device 50. Unlike in FIG. 2, the electric motor 4 is not controlled depending on the actuation of a control element, but depending on operating information that is representative of a rotational speed at which the driver rotates the pedal shaft 2. Alternatively or additionally, the operating information is representative of a torque exerted by the rider on the pedal shaft 2. Depending on this operating information, the control device 8 automatically determines control information and the electric motor 4 is operated accordingly. For example, this can enable automatic gear shifting and automatic torque assistance. The operating information is determined here as a function of measured values determined by a sensor 80, for example a cadence sensor or torque sensor.

The electric motor 4 in FIG. 3 is, for example, a brushless DC motor, for example with permanent magnets. Unlike in FIG. 2, in FIG. 3 the planet carrier 12 is not coupled in a rotationally fixed manner to the pedal shaft 2, but via a freewheel 22, that is, when the pedal shaft 2 is pedaled backwards, the planet carrier 12 is not driven. This means that it is not possible to brake by pedaling backwards. Nor can the electric motor 4 be used as a generator.

FIG. 4 shows a third embodiment of the drive device 50. Here, the electric motor 4 is an external rotor motor. The rotor 42 is coupled to the ring gear 14 of the planetary gear 10, the pedal shaft 2 is coupled to the planet carrier 12, and the sun gear 16 is coupled to the output element 6.

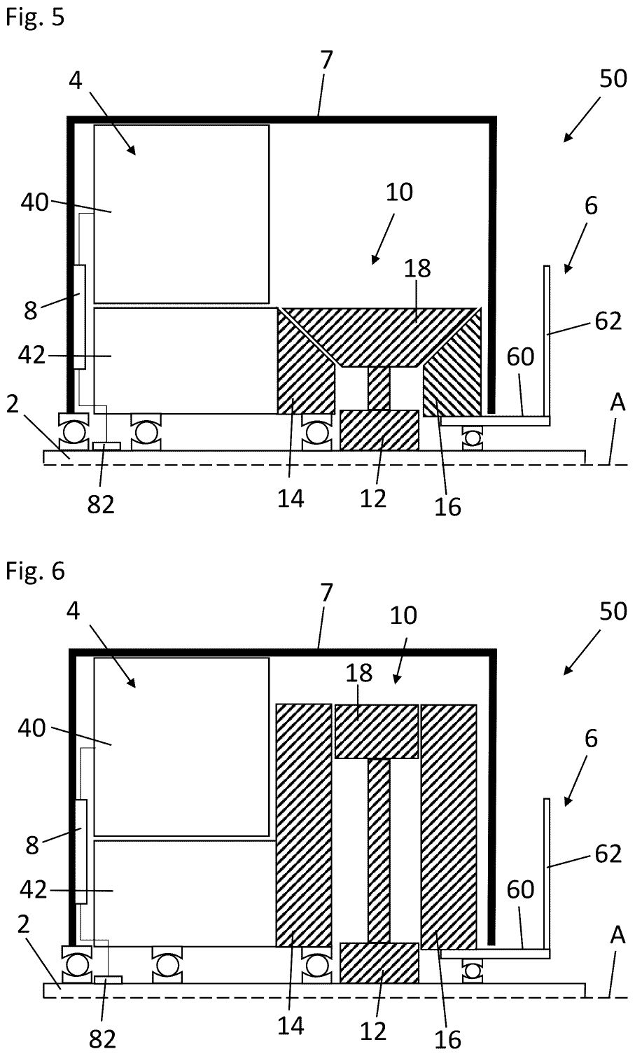

In the fourth embodiment of the drive device 50 according to FIG. 5, the epicyclic gearbox 10 is a bevel gear differential gearbox.

Here, the pedal shaft 2 is again connected to the planetary carrier 12 in a rotationally fixed manner. Epicyclic bevel gears 18 are provided on the epicyclic carrier 12, which are in engagement with a first bevel gear 14 and a second bevel gear 16. The first bevel gear 14 is connected in a rotationally fixed manner to the rotor 42 of the electric motor 4, and the second bevel gear 16 is connected in a rotationally fixed manner to the output element 6. The bevel gear differential gearbox is particularly space-saving.

In the embodiment of the drive device 50 shown in FIG. 6, the epicyclic gearbox 10 is a crown gear differential gearbox. The respective epicyclic gears 18 are spur gears and the gears 14, 16 coupled to the rotor 42 and the output element 6 are crown gears.

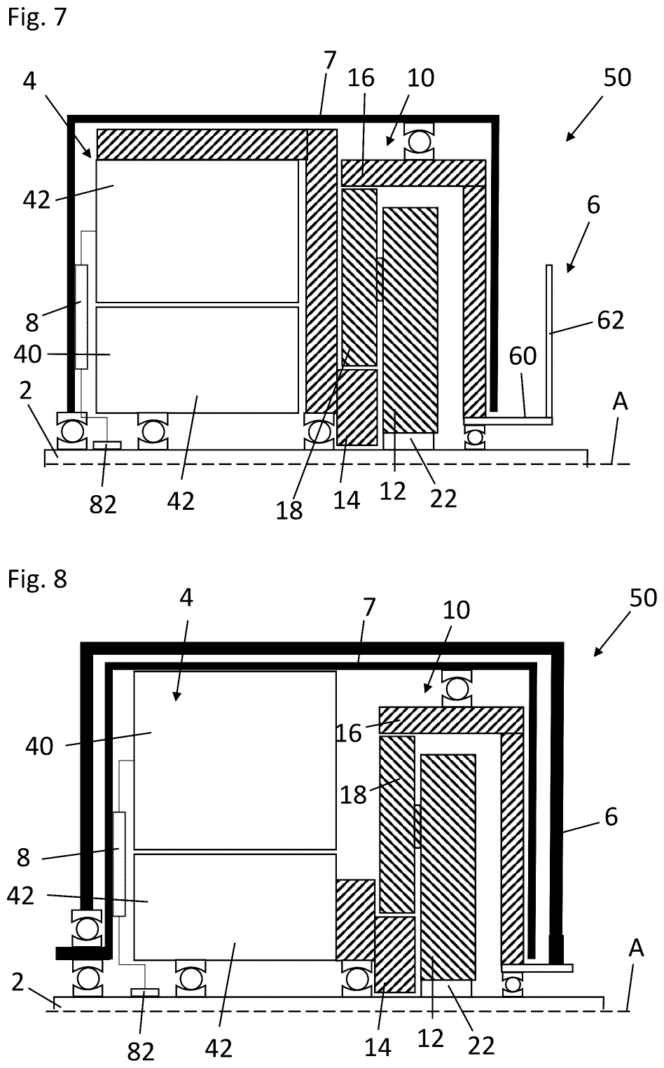

In the embodiment shown in FIG. 7, the electric motor 4 is again an external rotor motor. However, as shown in FIG. 3, for example, the rotor 42 is coupled to the sun gear 14, the pedal shaft 2 is coupled to the planet carrier 12, and the output element 6 is coupled to the ring gear 16.

The embodiment shown in FIG. 8 shows a drive device 50 that can be installed, for example, in the rear wheel hub of an electric bicycle. The output element 6 here is not a chainring, but a hub housing to which, for example, the spokes of the rear wheel are attached. Here, the pedal shaft 2 runs through the wheel, similar to a unicycle. Alternatively, the pedal shaft 2 could also be coupled to the planet carrier 12 via a chain or a belt. In this case, the pedal shaft 2 would not have to pass through the wheel.

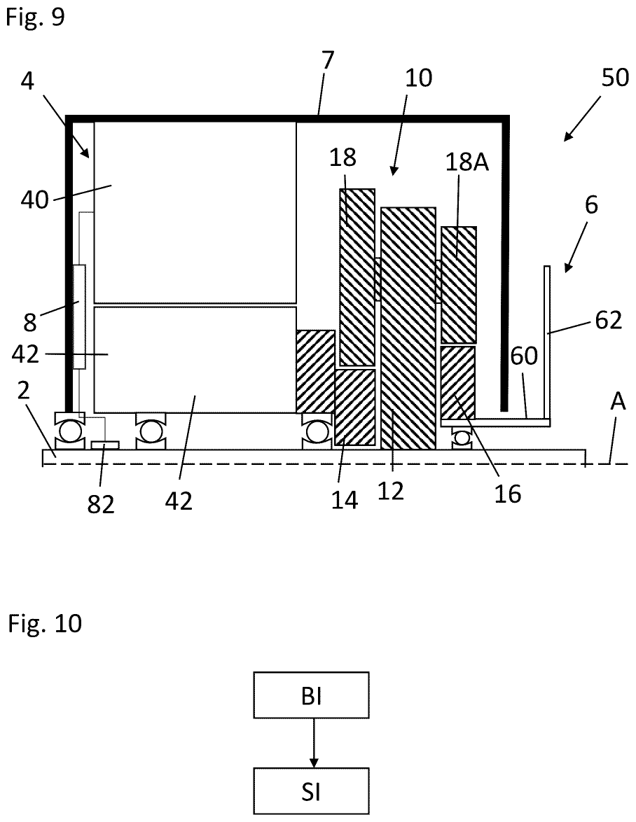

In the embodiment shown in FIG. 9, the epicyclic gearbox 10 is a planetary gearbox with two planetary stages. Here, there are two sets of planet gears 18, 18A, which are mounted on the planet carrier 12 so that they can rotate. The first set of planet gears 18 meshes with the sun gear 14, which is connected to the rotor 42 of the electric motor 4 in rotationally fixed manner. The other set of planet gears 18A is in engagement with another sun gear 16, which is connected in a rotationally fixed manner to the output element 6. The planet gears 18, 18A are arranged on both sides of the planet carrier 12. Opposite planet gears 18, 18A are connected to each other in a rotationally fixed manner.

FIG. 10 shows an embodiment of a method for operating a drive device, for example any of the drive devices shown in FIGS. 2 to 9. In this method, operating information BI that is representative of the operation of the electric bicycle is first provided or determined. The operating information BI may, for example, be representative of the operation of the twist grip and/or of a torque exerted by the rider on the pedal shaft and/or of a rotational speed at which the rider pedals the pedal shaft. Depending on the operating information BI, control information SI is then determined, which is used to control the motor.

It is understood that the foregoing description is that of the preferred embodiments of the invention and that various changes and modifications may be made thereto without departing from the spirit and scope of the invention as defined in the appended claims.

### LIST OF REFERENCE SIGNS

2 pedal shaft
4 motor
6 output element
7 housing
8 control device
9 battery
10 epicyclic gearbox
12 first element
14 second element
16 third element
18 epicyclic gear
18A epicyclic gear
22 freewheel
40 stator
42 rotor
50 drive device
60 hollow shaft
62 chainring
80 PWM generator
81 electric switch
82 sensor
100 electric bicycle
110 bicycle frame
120 down tube
130 control element
A rotational axis
BI operating information
SI control information

1. A drive device for an electric bicycle, the drive device comprising:
an epicyclic gearbox with three elements, all of said three elements being mounted so as to be rotatable about a common rotational axis;
a pedal shaft coupled to a first of said three elements to feed torque into said epicyclic gearbox;
a motor coupled to a second of said three elements to feed torque into said epicyclic gearbox;
an output element coupled to a third of said three elements to divert torque from the epicyclic gearbox; and,
wherein the drive device has only a single motor coupled to said output element such that torque can be transmitted from said single motor to said output element, said single motor coupled to said output element being said motor coupled to the second element.

2. The drive device of claim 1, wherein said motor is a brush DC motor with permanent magnets or a brushless motor with permanent magnets.

3. The drive device of claim 1, wherein a rotational speed of said motor is continuously variable.

4. The drive device of claim 1, wherein:
said first element is a carrier on which an epicyclic gear is mounted so as to be rotatable;
said second element is a gear which is in engagement with said epicyclic gear; and,
said third element is another gear which is in engagement with said epicyclic gear or in engagement with another epicyclic gear mounted on said carrier and connected in a rotationally fixed manner to said epicyclic gear.

5. The drive device of claim 4, wherein:
said epicyclic gearbox is a planetary gearbox;
said first element is a planet carrier;
said second element is a sun gear; and, said third element is a ring gear or another sun gear.

6. The drive device of claim 4, wherein:
said epicyclic gearbox is a bevel gear differential gearbox;
said first element is an epicyclic gear carrier;
said second element is a bevel gear; and,
said third element is another bevel gear.

7. The drive device of claim 4, wherein:
said epicyclic gearbox is a crown gear differential gearbox;
said first element is an epicyclic gear carrier;
said second element is a crown gear; and,
said third element is another crown gear.

8. The drive device of claim 1 further comprising:
a control device connected to said motor for signal transmission; and,
said control device being configured to determine control information for controlling said motor depending on operating information representative of an operation of the electric bicycle.

9. The drive device of claim 8, wherein the operating information is representative of at least one of torque exerted by a rider of the electric bicycle on said pedal shaft and a rotational speed at which the rider rotates said pedal shaft.

10. The drive device of claim 8, wherein the operating information is representative of manual actuation of a control element by a rider of the electric bicycle.
